(19) United States
(12) Patent Application Publication
(10) Pub. No.: US 2016/0110679 A1
(43) Pub. Date: Apr. 21, 2016

(54) SYSTEM AND METHOD FOR MONITORING AN IN-PROGRESS INVENTORY AUDIT

(71) Applicant: PICO Eenterprises, Inc., Holly, MI (US)

(72) Inventors: Dennis PUTNAM, Fenton, MI (US); George HATCHEW, Waterford, MI (US); Charles A. ANTHONY, Henderson, NV (US)

(21) Appl. No.: 14/515,842

(22) Filed: Oct. 16, 2014

(51) Int. Cl. G06Q 10/08

(52) U.S. Cl. CPC G06Q 10/087

(57) ABSTRACT

A portable workstation device may update an inventory area status associated with an inventory area of a store undergoing an in-progress inventory audit, responsive to receipt of product counts from an auditor device; and provide the inventory area status to a manager user device. The manager device may receive, for an in-progress inventory audit of a store, area status information indicative of progress of the inventory audit over a plurality of inventory areas of a floorplan model of a store; and display a floorplan map of the store according to the floorplan model, the floorplan map including a plurality of the inventory areas of the floorplan model displayed with appearances corresponding to the respective area status information for the corresponding inventory areas.

### TECHNICAL FIELD

Aspects disclosed herein generally relate to monitoring the progress, accuracy, and approval of an in-progress inventory audit.

### BACKGROUND

Retail stores maintain product inventory numbers electronically in a stocking system. These numbers may decrement when items are bought, and increment when items are restocked. As these numbers are only an estimate the actual state of the retail stock, an inventory audit may be performed from time to time to visually count the actual retail stock. One approach to visual inventorying is to print out a current inventory from the stocking system, and count the current stock for each item on the list. However, such approaches are error-prone, time-consuming, and difficult to manage.

### SUMMARY

In a first illustrative embodiment, a system includes a portable workstation device configured to update an inventory area status associated with an inventory area of a store undergoing an in-progress inventory audit, responsive to receipt of product counts from an auditor device; and provide the inventory area status to a manager user device configured to display a floorplan map of the store, the floorplan map including a plurality of inventory areas illustrated, at their relative locations within the store, with appearances corresponding to their respective inventory area statuses.

In a second illustrative embodiment, a system includes a portable inventory manager device configured to receive, from a portable workstation device managing an in-progress inventory audit of a store, area status information indicative of progress of the inventory audit for a plurality of inventory areas of a floorplan model of a store, the floorplan model defining locations of inventory areas within the store; and display a floorplan map of the store according to the floorplan model, the floorplan map including a plurality of the inventory areas of the floorplan model displayed, at their relative locations within a store, with appearances corresponding to the respective area status information for the corresponding inventory areas.

In a third illustrative embodiment, a non-transitory computer-readable medium comprising instructions of an audit manager application that, when executed by a processor of a manager device, cause the manager device to receive, for an in-progress inventory audit of a store, area status information indicative of progress of the inventory audit over a plurality of inventory areas of a floorplan model of a store; and display a floorplan map of the store according to the floorplan model, the floorplan map including a plurality of the inventory areas of the floorplan model displayed with appearances corresponding to the respective area status information for the corresponding inventory areas.

### BRIEF DESCRIPTION OF THE DRAWINGS

FIG. 1 illustrates an example system for managing an inventory audit for a retail store;

FIG. 2 illustrates an example user interface of a dashboard view of the current inventory audit status;

FIG. 3 illustrates an example user interface of an alternate dashboard view of the current inventory audit status;

FIG. 4 illustrates an example user interface of a floorplan view of the current inventory audit status;

FIG. 5 illustrates an example user interface a details window of a selected inventory area of the floorplan view;

FIG. 6 illustrates an example user interface of a change description dialog for a selected inventory area of the floorplan view;

FIG. 7 illustrates an example user interface of a review area section report for a selected inventory area of the floorplan;

FIG. 8 illustrates an example user interface of a walkout report for a selected inventory area of the floorplan;

FIG. 9 illustrates an example user interface of a detail report for a selected inventory area of the floorplan;

FIG. 10 illustrates an example user interface a selected inventory area of the floorplan;

FIG. 11 illustrates an example user interface of an auditor counts edits screen;

FIG. 12 illustrates an example user interface of a high value items screen;

FIG. 13 illustrates an example user interface of an overrides screen;

FIG. 14 illustrates an example user interface of a missing areas screen;

FIG. 15 illustrates an example user interface of a duplicate areas/sections screen;

FIG. 16 illustrates an example process for retrieving audit packages for upcoming inventory audits;

FIG. 17 illustrates an example process for performing an in-store inventory audit of a store;

FIG. 18 illustrates an example process for displaying a floorplan map of an in-progress inventory audit of a store;

FIG. 19 illustrates an example process for reviewing and approving product counts of an in-progress inventory audit of a store; and

FIG. 20 illustrates an example process for updating product counts for an in-progress inventory audit of a store.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A portable workstation device may receive an audit package from a server device. The audit package may include information useful for performing an inventory audit of a store, such as a floorplan model of the store, a price list of the items to be inventoried, and optionally a previous count of inventoried items. Auditor devices may be loaded with information from the audit package, and used by operators to visually count and record the store inventory. The auditor devices may provide product counts of the counted items to the portable workstation device. Manager devices in communication with the portable workstation device may display status information regarding the in-progress visual inventory, and may facilitate the review and approval of the product counts. The status information display may include floorplan map of the store being audited, with the inventory areas of the store being displayed with appearances indicative of the current status of the audit for the corresponding inventory areas. When reviewing the audit information for approval, the auditor manager may compare the received counts for variance with a previous audit, and may approve or correct outlier counts exceeding predetermined quantity or dollar amounts. By using the manager devices, auditors may be able to visually identify which areas of the store have been counted or need to be counted, and which areas have been approved or are ready for auditor approval. Once the inventory audit has been completed and approved, the finalized product counts may be sent to the server device to be archived and used as a baseline for comparison with later inventory audits of the store.

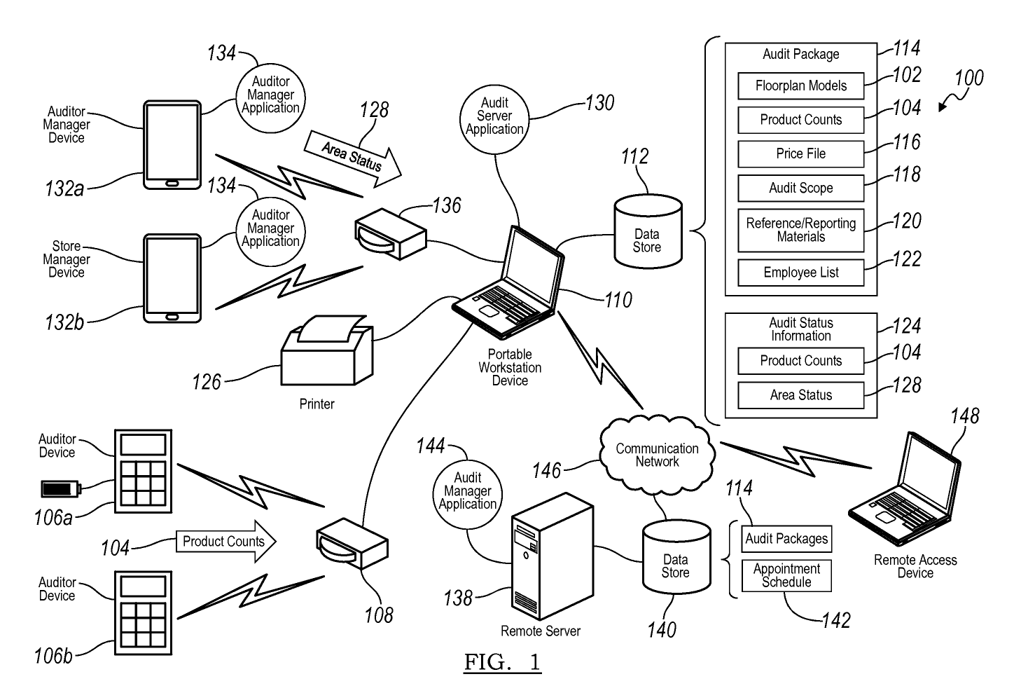

FIG. 1 illustrates an example system 100 for managing an inventory audit for a retail store. As illustrated, the system 100 includes one or more auditor devices 106 configured to provide product counts 104 to a portable workstation device 110 via an auditor device hub 108. The system 100 further includes one or more audit manager devices 132 utilizing an audit manager application 134 to monitor the product counts 104 and provide inventory area statuses 128 to the portable workstation device 110 via a tablet device hub 136. The portable workstation device 110 may be configured to host an audit server application 130 configured to manage the audit, and a data store 112 configured to maintain audit packages 114 defining the store audit to be performed and audit status information 124 including the current status of the inventory audit. The audit packages 114 may include information useful for performing the inventory audit, such as a floorplan model 102 of the store, previous product counts 104 of the store, a price file 116 of the inventory items to be counted, an audit scope 118 indicating details of what items to count, reference/reporting materials 120, and an employee list 122 of the personnel to perform the count. The system 100 further includes a remote server 138 hosting a remote data store 140 of audit packages 114 for various stores, and an appointment schedule 142 for completed and upcoming audits. In some examples, the remote server 138 may be configured to utilize an audit monitoring application 144 to receive the audit status information 124 from the portable workstation device 110 over a communication network 146. The system 100 may also include one or more remote access device 148 configured to access the remote server 138 over the communication network 146 to access the audit status information 124.

The floorplan model 102 may include various types of computer information useful for displaying a graphical map of inventory areas of a store. The inventory areas may include, as some non-limiting examples, a store perimeter, aisle shelving, aisle endcaps, gondolas, dump bins, seasonal display areas, register areas, or other areas or structures of a store for which inventory information may be collected, edited, viewed or otherwise maintained. The floorplan model 102 may accordingly include approximate sizing and location information for the various inventory areas of the store that include items to be counted.

In many cases, inventory areas of the store may include multiple discrete sections that may be counted individually. For example, store aisle shelving may include runs of multiple sections (e.g., four foot sections of shelving), where each section is counted in order (e.g., from top to bottom, from left to right) before proceeding to the next section. Accordingly, the floorplan model 102 may include indications of the number of sections included in each inventory area. These numbers of sections may aid in the determination of relative aisle lengths for visually representing the floorplan model 102, as well as in the referencing of locations of inventoried items within the store. The floorplan model 102 may also include textual labels of the inventory areas of the store to provide a general identification of the types of items available in the respective areas (e.g., condiments, cereal, baking, baby items, seasonal, etc.).

The floorplan model 102 may also include numeric designations of the inventory areas that may be useful for quickly identifying the inventory areas. For example, inventory areas that are aisles of the store may be numbered in a consistent aisle and side order (e.g., the front end-cap of first aisle may be numbered “101,” the right side of the first aisle may be numbered “102,” the back end-cap of the first aisle may be numbered “103,” the left side of the first aisle may be numbered “104,” the front end-cap of the second aisle may be numbered “201,” etc.). As another example, inventory areas at the perimeter of the store may be assigned numbers in a predetermined range (e.g., increasing in a clockwise manner from a base number assigned to the front of a store).

The product counts 104 may include data indicative of the amounts of items or stock counted by an operator of an auditor device 106. In an example, the product counts 104 may include a listing of product SKUs, where for each SKU the product counts 104 further include one or more totals or subtotals of inventory of that corresponding item.

The auditor device 106 may include one or more controls configured to receive entry of product counts 104 from device operators. In an example, the auditor device 106 may include a scanner device, such as a barcode reader, that may be used by an operator to scan an item or shelf label of an item to be counted. The scanner device may be external to the auditor device 106 (e.g., as illustrated for the auditor device 106-A), or in other cases may be internal to the auditor device 106.

The auditor device 106 may also include a keypad or other input controls through which the product counts 104 and item SKUs may be entered. For instance, the operator may use the keypad to manually enter a SKU or UPC directly (e.g., for items that do not readily scan). Moreover, the operator may use the keypad to enter a total number of items of a particular SKU. As another possibility, operator of the auditor device 106 may utilize the numeric keypad to enter the number of items as a sequence of arithmetic operations. For example, a count of forty items of a particular SKU may be entered as a chain sequence such as “12+12+12+4,” indicating that three cases of twelve items and then four more items were counted. As another example, a count of 120 items may be entered as “6*4*5,” indicating a count of a block of product six wide, four deep, and five high. To facilitate later verification of the product counts 104 input by the operators, the product counts 104 may include the particular chain sequence of operations entered into the auditor device 106, not merely the total amount counted.

The auditor device hub 108 may be connected to the portable workstation device 110, and may be configured to facilitate secure communication between the portable workstation device 110 and the various auditor devices 106 in use throughout the store. As some examples, the auditor device hub 108 may be configured to communicate with the auditor devices 106 via BLUETOOTH, 2.4 Ghz wireless connectivity, or WiFi connectivity. As one aspect of providing security for the communications, the auditor device hub 108 may limit or exclude communications from devices other than those devices validated for use with the auditor device hub 108. Additionally or alternately, the auditor device hub 108 may be configured to utilize a proprietary protocol and/or support encryption of communications between the auditor devices 106 and the portable workstation device 110.

The auditor devices 106 may be configured to communicate via the auditor device hub 108 to provide product counts 104 to the portable workstation device 110. In an example, when an operator of the auditor device 106 completes an audit of a section of an inventory area, the operator may select an upload function of the auditor device 106 to provide the product counts 104 for that counted section to the portable workstation device 110. In some cases, these batches of product counts 104 may be assigned transactions identifiers (e.g., audit-unique numerical designations) and each product count 104 within the transaction may be assigned a loop identifier unique to the transaction (e.g., numerically increasing values starting from the beginning of the transaction).

The portable workstation device 110 may include various types of computing apparatus, such as a laptop computer, a computer workstation, a server, a desktop computer, a tablet computer, or some other computing system and/or device that may be moveable to the store to be inventoried. Computing devices, such as the portable workstation device 110, generally include a memory on which computer-executable instructions may be maintained, where the instructions may be executable by one or more processors of the computing device. Such instructions and other data may be stored using a variety of computer-readable media. A computer-readable medium (also referred to as a processor-readable medium or storage) includes any non-transitory (e. g., tangible) medium that participates in providing data (e.g., instructions) that may be read by a computer (e.g., by the processor of the portable workstation device 110). In general, processors receives instructions, e.g., from the memory via the computer-readable storage medium, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Java Script, Perl, PL/SQL, etc.

The data store 112 may be one such application included on the storage of the portable workstation device 110. The data store 112 may include instructions that, when loaded into memory and executed by the portable workstation device 110, cause the portable workstation device 110 to perform database functionality including the storage, update, and retrieval of information. Databases or data repositories such as the data store 112 may include various kinds of mechanisms for storing, accessing, and retrieving various kinds of data, including a hierarchical database, a set of files in a file system, an application database in a proprietary format, a relational database management system (RDBMS), etc. The data store 112 may employ features of the computer operating system of the portable workstation device 110, such as the file system to store and retrieve files stored in various formats. An RDBMS may employ a query language for the maintained information, such as the Structured Query Language (SQL) in addition to a language for creating, storing, editing, and executing stored procedures, such as the PL/SQL language mentioned above.

The data store 112 may be configured to maintain information useful for management and performance of the inventory audit. For example, the data store 112 may maintain one or more audit packages 114. An audit package 114 may include a set of information corresponding to a particular audit to be performed at a specific store. For example, the audit package 114 may include a floorplan model 102 of the store to be audited, a set of previous product counts 104 of the store, a price file 116 of the inventory items to be counted, an audit scope 118 indicating details of what to count, reference/reporting materials 120, and an employee list 122 of the personnel to perform the count, as some possibilities. In order to have relevant information available before an audit begins, the audit package 114 may be stored to the portable workstation device 110 in advance of performance of the audit (e.g., downloaded from the remote server 138, discussed in greater detail below).

The price file 116 may include information indicative of the specifics products to be audited by the system 100. In an example, the price file 116 may include a listing of product SKUs, where for each SKU, the price file 116 further includes information such as item price, item department, and textual name or description of the item. The price file 116 may accordingly be used to allow the system 100 to identify price and other item information for the inventory being scanned by the auditor devices 106, as well as to identify whether any unknown items are scanned that do not appear in the price file 116.

The audit scope 118 may include information indicative of the scope of the store audit. As an example, for stores that utilize third-party services to maintain soda-pop sections, bakery, or periodical sections, the audit scope 118 may indicate that those areas of the floorplan model 102 are not to be audited. As another example, the audit scope 118 may indicate other items that should or should not be audited, such as whether or not to audit bulk or unpackaged goods (e.g., bulk produce, deli counter items, etc.).

The reference/reporting information 120 may include information of any type beneficial to the auditing process such as guides, forms etc. The employee list 122 may include information indicative of which operators of the auditor devices 106 are tasked with auditing the store. Thus, the employee list 122 information may be used in conjunction with the floorplan model 102 to provide task assignments to the operators of the auditor devices 106.

The data store 112 may be further configured to maintain audit status information 124 related to an audit that is in progress. The audit status information 124 may include the current product counts 104 provided by the auditor devices 106 to the portable workstation device 110. The audit status information 124 may further include inventory area statuses 128 indicating the count and approval status of the product counts 104 for specific inventory areas of the store. In an example, the inventory area status 128 may include an indication of the approval status of the current product counts 104 by inventory area (e.g., unknown inventory area, count data unavailable for inventory area, count data in progress for inventory area, inventory area count data approved by auditor for store review, inventory area count data approved by store, etc.)

The audit server application 130 may be another application or library included on the storage of or otherwise accessible to the portable workstation device 110. The audit server application 130 may be configured to manage the audit status information 124 maintained by the data store 112. The audit server application 130 may be further configured to provide a user interface through which audit status information 124 may be visualized for a user of the portable workstation device 110. For example, the audit server application 130 may be configured to provide review and approval functionality with respect to the inventory area statuses 128 and current product count 104 of the audit status information 124. The audit server application 130 may accordingly allow users to flag, review, and correct possible errors in the product counts 104.

The manager devices 132 may include various devices usable by auditor personnel or store personnel to access the audit status information 124 when remote from the portable workstation device 110. For instance, manager devices 132 may be used by audit personnel managers (e.g., the auditor manager device 132-A), or by store managers (e.g., the store manager device 132-B). In an example, auditor managers may use their manager devices 132-A to perform a first review and approval of the inventory counts 104, and store managers may use their manager devices 132-B to perform a second review and approval of the inventory counts 104 once they are approved by the auditor managers.

Similar to as discussed above with respect to the portable workstation device 110, the manager devices 132 may include various types of computing apparatus including a memory on which computer-executable instructions may be maintained, where the instructions may be executable by one or more processors of the computing device. Thus, while the manager devices 132 are described in the context of tablet devices, the manager devices 132 may additionally or alternately include other classes of devices including laptop computers, portable digital assistants (PDAs), handheld computers, mobile phones, computer workstations, servers, desktop computers, or some other computing system and/or device.

In an example, the manager devices 132 may be configured to access the audit status information 124 of the portable workstation device 110 by communicating with the portable workstation device 110 via a web browser application. As another possibility, the manager devices 132 may execute the audit manager application 134, or “app”, configured to provide secure access to the portable workstation device 110. In some cases, the audit manager application 134 may be installed to the manager devices 132 by the audit operator. In other cases, the audit manager application 134 may be downloaded from an application store such as the App Store provided by Apple, Inc. of Cupertino, Calif., or the Google Play store provided by Google, Inc. of Mountain View, Calif.

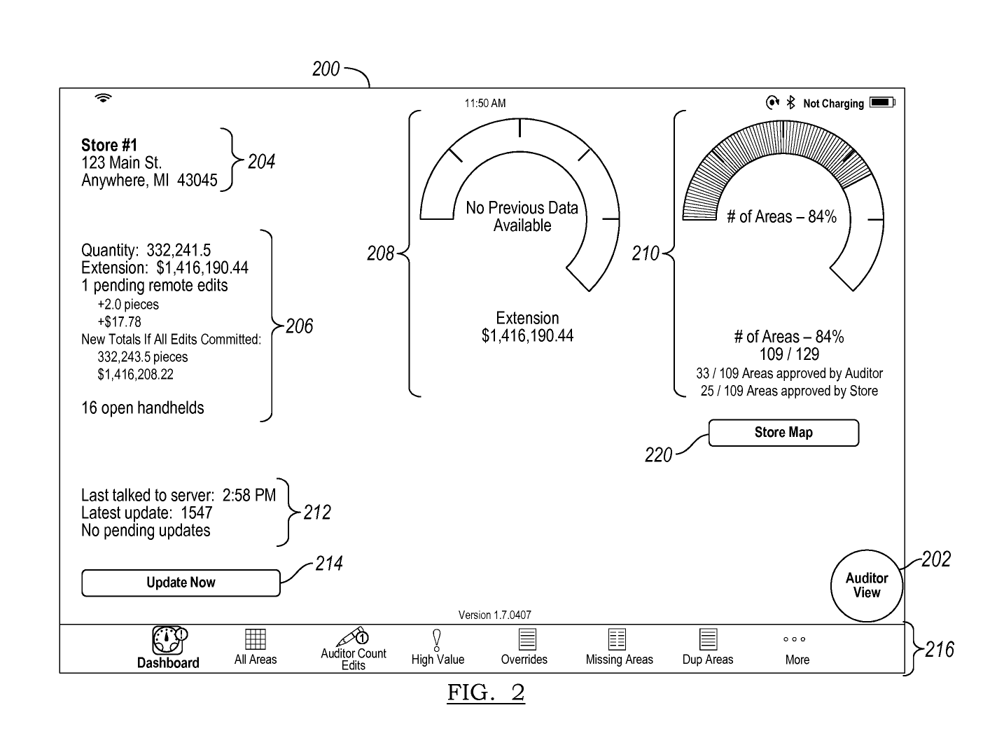

Using the audit manager application 134, the manager devices 132 may be configured to display a dashboard indicative of the overall status of the product counts 104, as well as provide a display of the floorplan model 102 to provide a detailed visual representation of the progress of the inventory audit of the store. Using the display of the floorplan model 102, an operator of the manager device 132 may be able to review and approve areas for which inventory has been collected for store review. The audit manager application 134 may be further configured to receive updated audit status information 124 from the portable workstation device 110, and update the rendering of the floorplan model 102 based on the new audit status information 124. Further aspects of the operation of the manager devices 132 are discussed in detail with respect to FIGS. 2-20 below.

The manager devices 132 may be configured to communicate with the portable workstation device 110 via the auditor device hub 136. The auditor device hub 136 may utilize various wireless technologies to communicate with the manager devices 132, such as BLUETOOTH, 2.4 Ghz wireless connectivity, or WiFi, as some non-limiting examples. Accordingly, users of the manager devices 132 may be able to freely move throughout the store when reviewing the audit status information 124 provided from the portable workstation device 110.

Similar to as discussed above with respect to the portable workstation device 110, the remote server 138 may include various types of computing apparatus including a memory on which computer-executable instructions may be maintained, where the instructions may be executable by one or more processors of the computing device. The remote server 138 may be configured to maintain a remote data store 140 including the appointment schedule 142 of when and where in-store inventory audits are to be performed, as well as the audit packages 114 to be downloaded to the portable workstation device 110 before performing the scheduled in-store inventory audits

The portable workstation device 110 may be configured to access the remote server 138 to download audit packages 114. For example, based on the appointment schedule 142, the portable workstation device 110 may retrieve the audit package 114 for the next audit to be performed, the audit packages 114 for the next day of audits to be performed, the audit packages 114 for the next week of audits to be performed, as some non-limiting possibilities. Thus, by retrieving the audit package 114 in advance of performing an inventory audit, the portable workstation device 110 may be able to ensure that the data for the audit is accessible, even if network connectivity is unavailable on-site at the store being inventoried.

In some cases, however, network connectivity may be available at the on-site at the store being inventoried via a communication network 146. The external communication network 146 may include one or more interconnected communication networks such as the Internet, a cable television distribution network, a satellite link network, a local area network, a wide area network, and a telephone network, as some non-limiting examples. In such cases where network connectivity to the communication network 146 is available on-site to the portable workstation device 110, the portable workstation device 110 may be configured to provide the audit status information 124 to the remote server 138, allowing the remote server 138 site to be able to monitor the status of the inventory while the inventory is being performed (e.g., with a view similar to that described with respect to the manager devices 132).

The remote access devices 148 may include various devices usable to access the remote server 138 over the external communication network 146. The remote access devices 148 may include, as some non-limiting examples, laptop computers, tablet or other handheld computers, mobile phones, computer workstations, servers, desktop computers, or some other computing system and/or device. In cases where the portable workstation device 110 may provide the audit status information 124 to the remote server 138, the remote access devices 148 may be used to allow users to monitor the status of the in-progress inventory audits from anywhere that communication network 146 access may be available. Further aspects of the audit monitoring performed by the manager devices 132 and the remote access devices 148 are discussed in detail below.

FIG. 2 illustrates an example user interface 200 of the audit manager application 134 displaying a dashboard view of the current inventory audit status. The user interface 200 may be presented, for example, on a display of the manager device 132-A accessing the audit server application 130 of the portable workstation device 110. The user interface 200 may be provided by the portable workstation device 110, for example, responsive to a user logging into the audit server application 130 using his or her user account credentials as an initial view of the audit manager application 134. The audit manager application 134 may be configured to display a dashboard user interface in a display screen of the manager device 132 (e.g., tablet) indicative of the overall status of the product counts 104. This view may provide a high-level view of the current audit status, such a percentage completion, value of inventory audited, etc.

As illustrated, the provided account credentials are associated with an audit manager of the system 100, and thus the user interface 200 illustrates a dashboard view for an auditor manager. The user interface 200 may include a view type label 202 to indicate to the user that the user interface 200 is for use by a user having an auditor manager role. (A dashboard view for a store manager is discussed in detail below with respect to the user interface 300.)

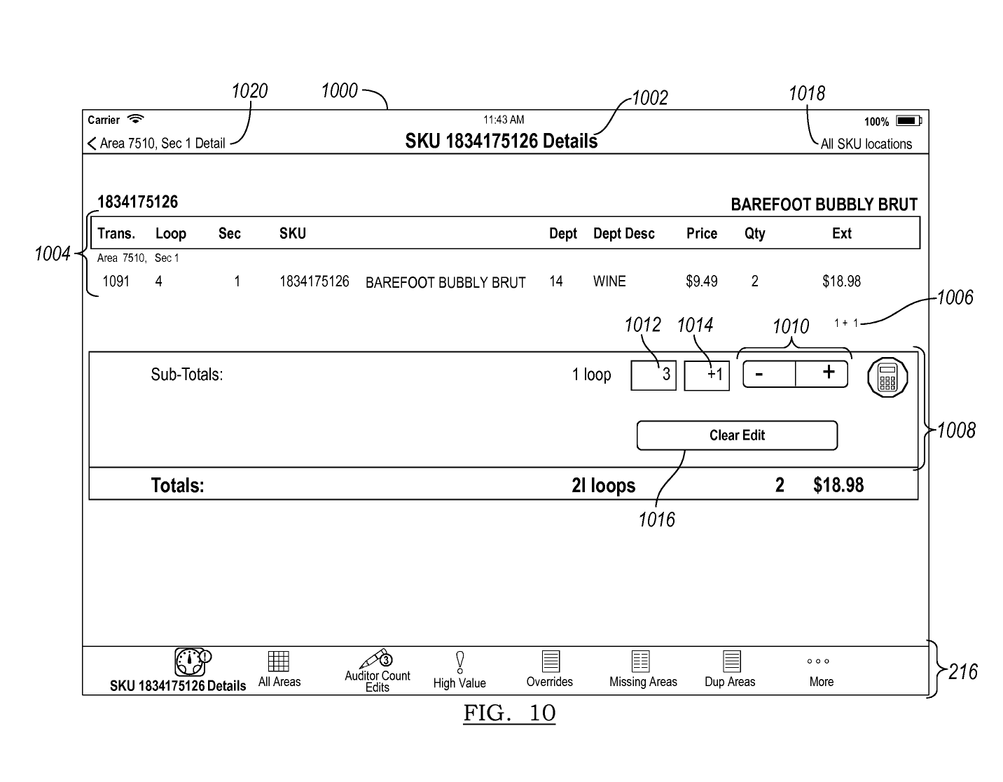

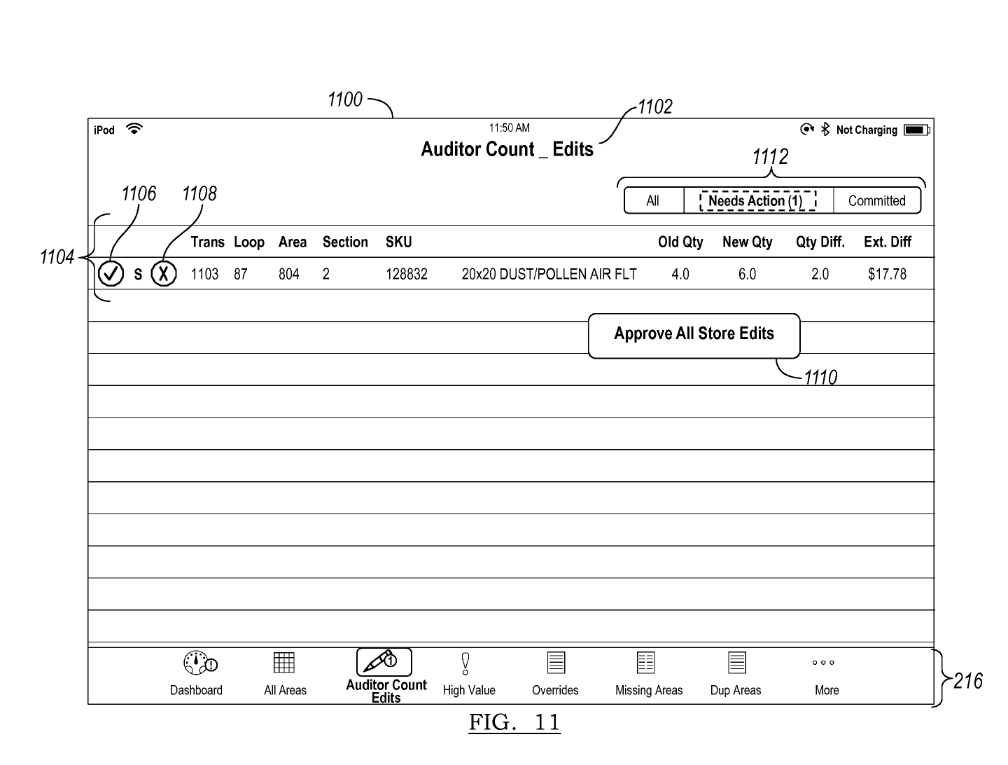

The user interface 200 may further include various controls configured to provide a textual view of the present status of the inventory audit. For example, a store information label 204 may indicate general information about the store location being audited, such as store name (e.g., “Store #1”), store number, and store address. The store information may be identified from the audit package 114. An audit statistics label 206 may include statistics regarding the store location being audited, such as a total number of items inventoried according to the product counts 104, a total retail price of the counted items determined according to the product counts 104 and the price file 116 (sometimes referred to as inventory extension), a current number of edits to the product counts 104 that are pending, updated totals if the pending edits are approved, and a number of auditor devices 106 (e.g., handhelds) currently being used to inventory the store. Edits are explained in further detail below with respect to FIGS. 10-11.

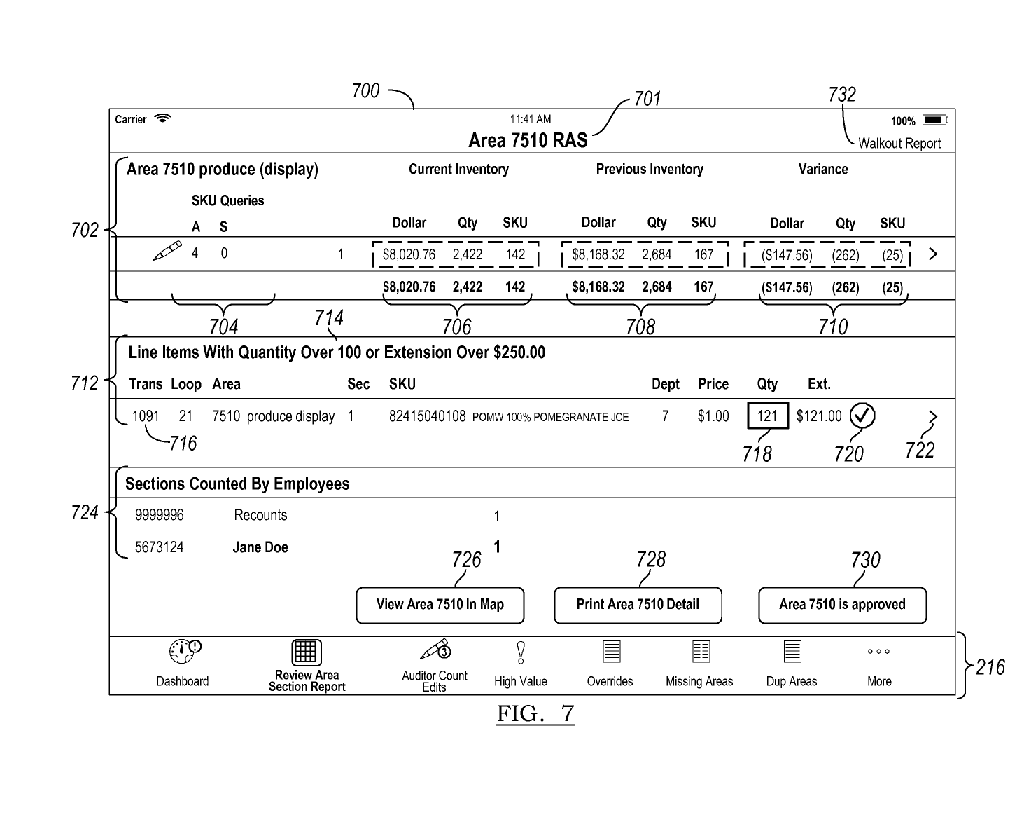

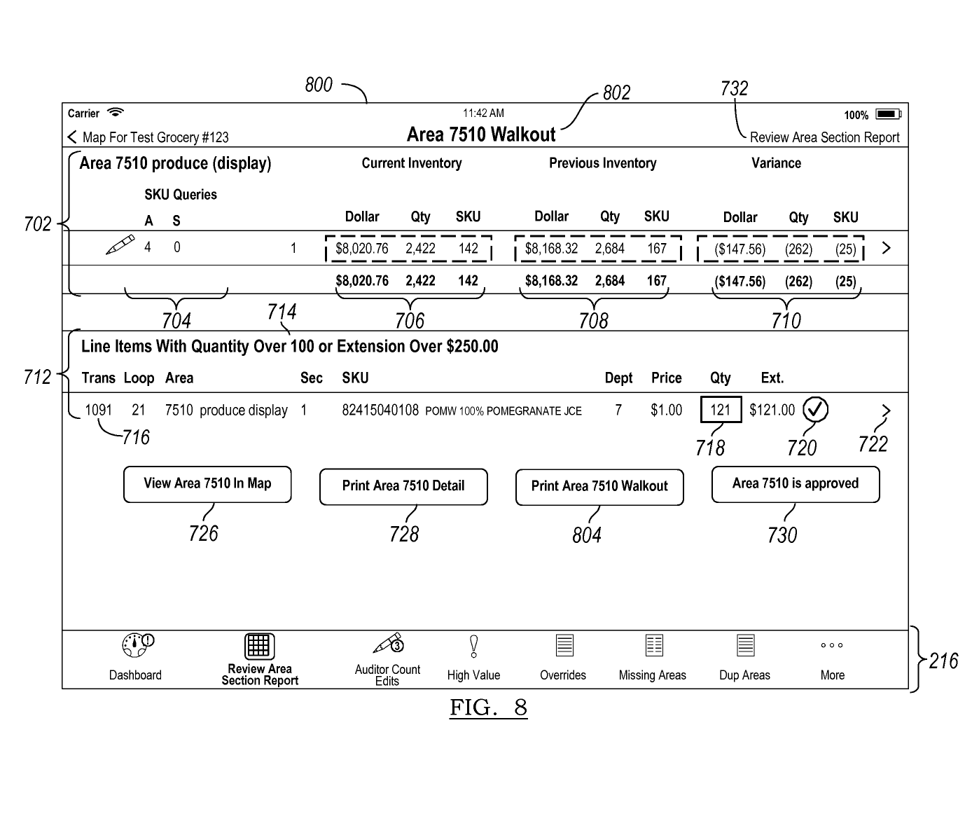

The user interface 200 may also include various controls configured to provide a graphical view of the present status of the inventory audit. For example, an inventory extension gauge 208 may be used to provide a graphical representation of the progress of the inventory in terms of dollar amount (e.g., in terms of extension) as compared to the previous completed inventory count information (e.g., included in the audit package 114). As another example, an inventory area gauge 210 may be used to provide a graphical representation of the progress of the inventory in terms of physical areas of the store (e.g., in terms of percentage of completed sections of the floorplan model 102 of the audit package 114). For example, as illustrated “109” out of “129” or “84%” of the inventory areas of the floorplan model 102 have been counted by the auditor devices 106. Out of those 109 counted inventory areas, 33 have been approved by the audit manager user, and 25 have been approved by the store manager. Furthers aspects of the approval process are discussed in detail below with respect to FIGS. 7-8.

The user interface 200 may also include various controls relating to the communication of the manager device 132 with the portable workstation device 110. For example, a server information label 212 may include general information about the time at which the manager device 132 and the portable workstation device 110 last communicated, a number of product counts 104 retrieved in that communication, and whether any pending updates remain to be downloaded by the manager device 132 from the portable workstation device 110. An update now control 214 may be configured to request the pending updates from the portable workstation device 110 when selected. Additionally or alternately, the pending updates may be periodically or otherwise automatically downloaded by the manager device 132.

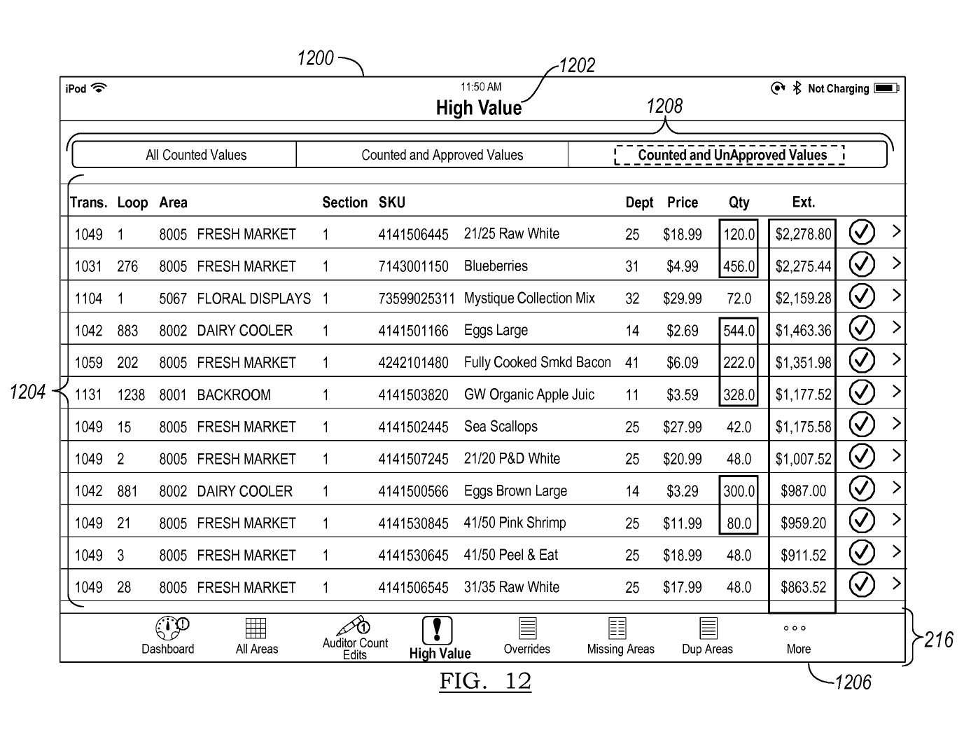

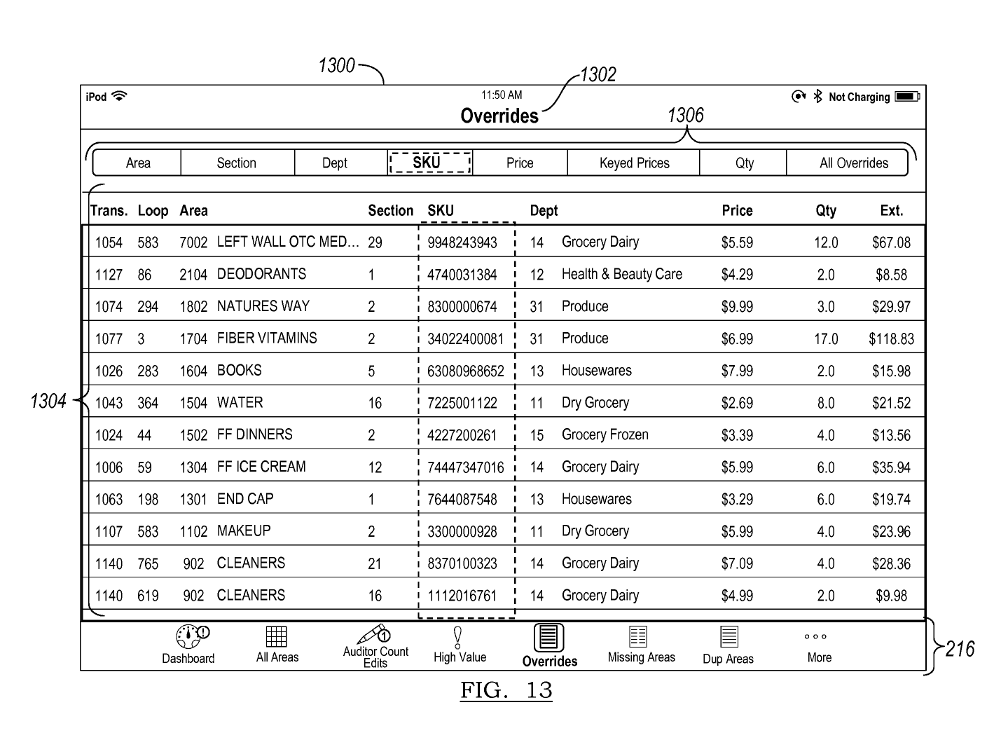

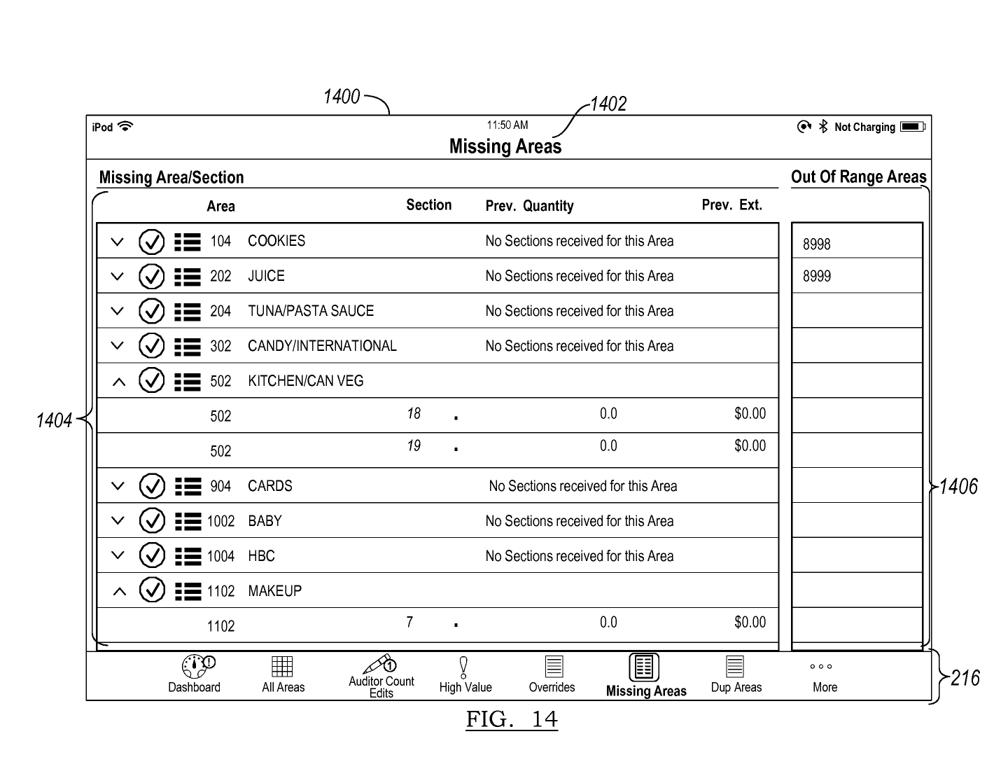

The user interface 200 may further include a feature list 216 configured to display a list of available views of the current inventory audit status. For example, a dashboard control may be configured to cause the audit manager application 134 to display the dashboard user interface 200. An all areas control may be configured to cause the audit manager application 134 to display an all areas view. Additionally, an auditor count edits control may be selected to display an auditor count edits view (discussed in detail below with respect to FIG. 11), a high value control may be selected to display high value view (discussed in detail below with respect to FIG. 12), an overrides control may be selected to display a high value view (discussed in detail below with respect to FIG. 13), a missing areas control may be selected to display a missing areas view (discussed in detail below with respect to FIG. 14), and a duplicate areas control may be selected to display a duplicate areas view (discussed in detail below with respect to FIG. 15).

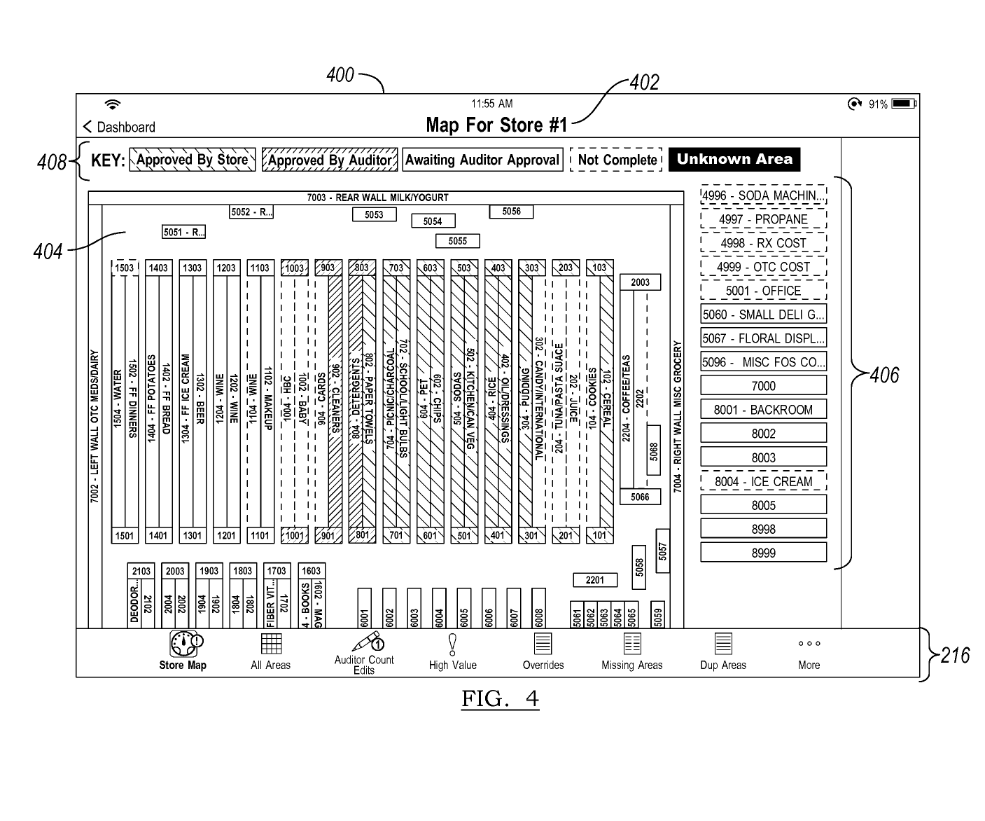

The user interface 200 may further include a store map 220 control configured to cause the audit manager application 134 to display a floorplan model 102 view of the current inventory audit status. Further aspects of the floorplan model 102 view are discussed in detail below with respect to FIGS. 4-6.

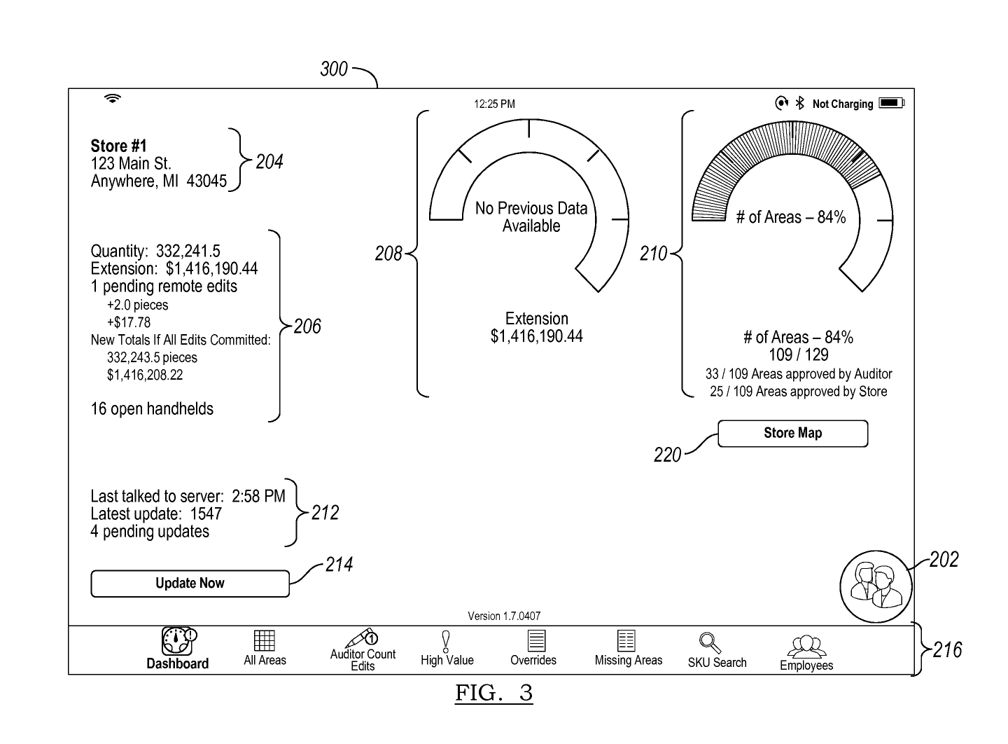

FIG. 3 illustrates an example user interface 300 of the audit manager application 134 displaying an alternate dashboard view of the current inventory audit status. Similar to the user interface 200, the user interface 300 may be presented, for example, on a display of the manager device 132-B accessing the audit server application 130 of the portable workstation device 110. The user interface 300 may be provided by the portable workstation device 110, for example, responsive to a user logging into the audit server application 130 using his or her user account credentials as an initial view of the audit manager application 134. As illustrated, the provided account credentials are associated with a store manager of the system 100, and thus the user interface 300 illustrates a dashboard view for the store manager. As compared to the user interface 200, the view type label 202 of the user interface 300 indicates that the current user is a store manager user.

Moreover, as compared to the user interface 200, the feature list 216 may include different list of available views of the current inventory audit status tailored for store manager users rather than audit manager users. For example, certain reporting features may be available to audit manager users but unavailable for store manager users. As an example, as auditors may validate product counts 104 before they are made available for approval to the store managers, auditor reports for reviewing product counts 104 for the inventory areas (e.g., review area section (RAS) reports) may be unavailable to store manager users. However, store manager reports for reviewing product counts 104 for the inventory areas (e.g., walkout reports) may be available both to auditor managers and store managers, so that auditor managers may review how reports appear to store managers, and also to allow the store manager users to verify and approve the product counts 104 for the inventory areas.

FIG. 4 illustrates an example user interface 400 of the audit manager application 134 displaying a floorplan view of the current inventory audit status. As with the user interfaces 200 and 300, the user interface 400 may be presented on a display of the manager device 132. The user interface 400 may be displayed, for example, responsive to selection of the store map 220 control from the user interfaces 200 or 300. As shown, the user interface 400 may include a title label 402 to indicate to the user that the user interface 400 is displaying a floorplan model 102 for the store currently being audited. In the illustrated example, the title label 402 indicates that the “Store #1” is being audited.

The user interface 400 may also include a floorplan display 404 of the inventory areas of the floorplan model 102 arranged according to their relative locations within the store (i.e., the “Store #1” as illustrated). For example the floorplan display 404 may include aisles one through fifteen located in the center of the store, aisles sixteen through twenty-one located in the front left of the store, an aisle twenty-two at the far right of the store, checkout lanes located at the front center of the store, perimeter wall displays along the edge of the store, side and rear wall areas, and various dump bins or seasonal displays located near the rear wall and the front left corner. The inventory areas may be labeled according to the numeric designations and textual labels associated with the inventory areas in the floorplan model 102. For instance, the right-hand side of aisle ten is labeled with a numeric designation of 1002 and a textual label “BABY”, indicating that the right hand side of aisle ten generally includes baby-related merchandise.

In some cases, inventory areas of the floorplan model 102 may not be associated with geographic locations within the store. This may be because those areas were added to the store since the creation of the floorplan model 102, or simply because those areas did not have geographic locations assigned to them. To allow those areas to be represented, the user interface 400 may further include an inventory area listing 406 of areas for which geographic coordinates are not assigned. These inventory areas of the listing 406 may also be labeled according to the numeric designations and textual labels associated with the inventory areas in the floorplan model 102.

The user interface 400 may be configured to utilize the floorplan model 102 to display a detailed visual representation of the progress of the inventory audit of the store. To do so, the audit manager application 134 may render the sections of the floorplan model 102 of the user interface 400 with different appearances to correspond with the audit status information 124 for the corresponding sections of the store. In an example, the audit manager application 134 may display the sections of the floorplan model 102 in different colors, patterns, or textures according to their respective inventory area statuses 128. For instance, areas of unknown status may be provided in a first color, areas where product counts 104 are unavailable may be provided in a second color, areas where product counts 104 are in progress may be provided in a third color, areas where product counts 104 is approved by an auditor and ready for store review may be provided in a fourth color, and areas where product counts 104 are approved by store personnel may be provided in a fifth color. The user interface 400 may further include a key 408 configured to illustrate meanings of the various colors, patterns, or textures in which the floorplan model 102 is displayed.

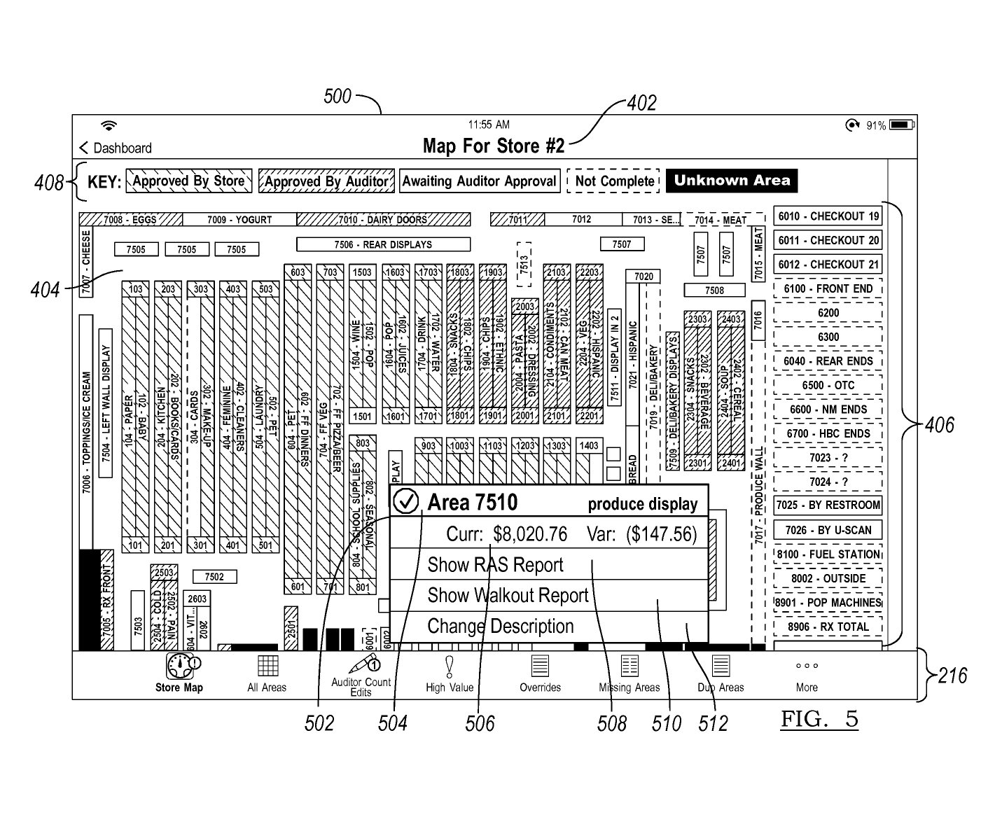

FIG. 5 illustrates an example user interface 500 of the audit manager application 134 displaying a details window 502 of a selected inventory area of the floorplan view. The user interface 500 may be displayed, for example, responsive to user selection of one of the inventory areas from the floorplan display 404 or inventory area listing 406.

In the illustrated example, details for an inventory area 7510 of “Store #2” are displayed in the details window 502. The details window 502 may include an information label 504 indicating which inventory area is selected, such as by numeric designation and textual label. The details window 502 may also include extension information 506 regarding the selected inventory area, such as the current total counted value (e.g., based on the product counts 104 and price file 116), and a difference from the prior product counts 104 (e.g., based on the current product counts 104 and the previous product counts 104 of the audit package 114, if available).

The details window 502 may also include commands that may be selected by the user to invoke various additional functionality. As an example, the details window 502 may include a change description command 512 that, when selected, is configured to invoke a change description dialog configured to allow the user to update the textual label associated with the selected inventory area. As another example, if the user is an auditor user, the details window 502 may include a show RAS report command 508 that, when selected, is configured to cause the manager device 132 to display a RAS report including details of the selected inventory area. A sample RAS report is illustrated below with respect to FIG. 7. As another example if the user is an auditor user or a store manager user, the details window 502 may include a show walkout report command 510 that, when selected, is configured to cause the manager device 132 to display a walkout report including details of the selected inventory area. A sample walkout report is illustrated below with respect to FIG. 8.

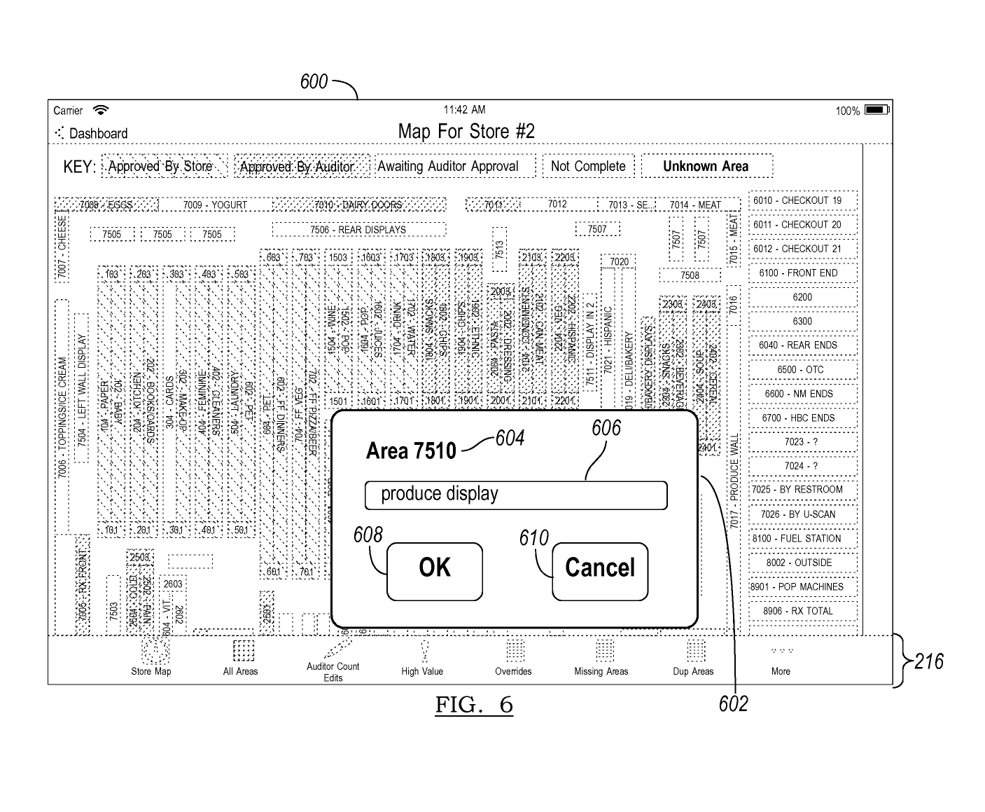

FIG. 6 illustrates an example user interface 600 of the audit manager application 134 displaying a change description dialog 602 for a selected inventory area of the floorplan view. The user interface 600 may be displayed, for example, responsive to user selection of the change description command 512 from the details window 502 displayed for a selected inventory area of the floorplan view.

The change description dialog 602 may include an information label 604 including an indication of the inventory area to be renamed such as the numeric designation, and an editable description control 606 defaulting to the current textual description associated with the inventory area. A user may modify the textual label using the editable description control 606. If the user interface 600 receives a selection of the OK control 608, the manager device 132 may send a message to the portable workstation device 110 to update the textual description of the inventory area with the new description, and the change description dialog 602 may be dismissed. If the user interface 600 receives a selection of the cancel control 608, then any updates to the textual description may be discarded and the change description dialog 602 may be dismissed. Once dismissed, the manager device 132 may revert to the user interface 400.

FIG. 7 illustrates an example user interface 700 of the audit manager application 134 displaying a RAS report for a selected inventory area of the floorplan. The user interface 700 may be displayed, for example, responsive to user selection of the show RAS report command 508 from the details window 502 displayed for a selected inventory area of the floorplan view. As illustrated, the user interface 700 may include a title label 701 to indicate to the user that the user interface 700 is displaying a RAS report of the store currently being audited (e.g., for inventory area 7510 in the given example).

The RAS report may include a summary report section 702 including overall information regarding the collected product counts 104 for the inventory area being reported on. The summary information may include, for example, a number of queries made by auditor manager users and by store manager users and for item details of SKUs 704 of the collected product counts 104 for the inventory area. As illustrated, four such queries were made by auditor managers, but none were made by store managers. An example item details report is discussed below with respect to FIG. 10.

The summary information may also include current inventory information 706 related to the product counts 104. This current inventory information 706 may include, for each section of the inventory area, a dollar amount of the collected product counts 104 (e.g., determined using the collected product counts 104 according to the information of the price file 116), a quantity of items that were counted (e.g., determined using the collected product counts 104), and a total number of unique SKUs counted (e.g., also determined using the collected product counts 104). The current inventory information 706 may further include totals for dollar amount, item quantity, and unique SKUs across all sections of the inventory area. In the illustrated example, the produce display has only one section, and therefore the totals match the information 706 for the only section. In other examples with multiple sections, it should be noted that the totals would be a total across the combination of all of the sections of the inventory area.

Similar to the current inventory information 706, the summary information may also include previous inventory information 708 related to the previous product count 104 information. The previous product count 104 may be identified according to the product counts 104 included in the audit package 114. The previous inventory information 708 may also include, for each section of the inventory area, a dollar amount of the collected product counts 104 (e.g., determined using the previous product counts 104 of the audit package 114 and the price file 116), a quantity of items that were counted (e.g., determined using the previous product counts 104), and a total number of unique SKUs counted (e.g., also determined using the previous product counts 104.)

The summary information may further include variance information 710 related to the differences between the current inventory information 706 and the previous inventory information 708. In the illustrated example, the variance information 710 includes differences in dollar amount, quantity, and unique SKUs between the current inventory 706 (i.e., the current product counts 104) and the previous inventory information 708 (i.e., the product counts of the audit package 114).

The RAS report may include a flagged count section 712 including summary information with respect to the collected product counts 104 that may require further confirmation. For example, the system 100 may define (or the user may customize) criteria that, when met, automatically indicate that a particular product count 104 should be confirmed before the inventory area is approved. As shown by the criteria description 714, the illustrated RAS report is configured to flag line items of the product counts 104 in which the quantity is over a threshold (e.g., 100 units), and/or where the extension amount exceeds a dollar threshold (e.g., $250.00). As further illustrated, the line item 716 includes a quantity of “121,” which meets the threshold quantity for inclusion in the flagged count section 712. The line item 716 further illustrates information about the flagged count, such as the area, section, SKU, SKU description (e.g., from the price file 116), department, unit price, quantity, and extension amount.

To illustrate which criteria are met for the line items 716 included in the flagged count section 712, the line item 716 may be illustrated with a criteria indication 718 indicating which element of the line item 716 for the product count 104 caused the product count 104 to be flagged for inclusion. The line item 716 may further include an approve control 720 that, when selected, allows the user to approve the line item 716, and an item detail control 722 configured to cause the audit manager device 132 to display an item details user interface (discussed in more detail below with respect to FIG. 10).

The RAS report may also include an employee section count section 724 including a listing of the identities of auditor personnel providing product counts 104 for the selected inventory area. For example, two users are illustrated as having contributed product counts 104 for the section one of the inventory area.

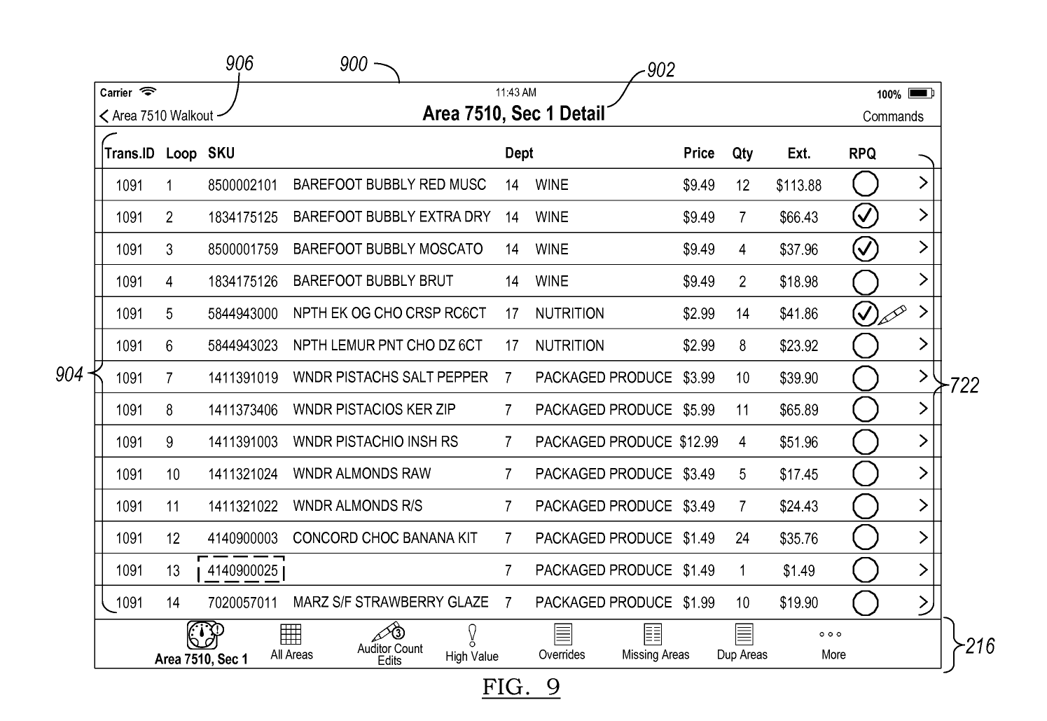

The RAS report may additionally include controls that may be invoked to facilitate the review of the product counts 104 for the selected inventory area. For example, the RAS report may include a view area in map control 726 that, when selected, is configured to cause the manager device 132 to display a floorplan view of the current inventory audit status such as described above with respect to FIG. 4, but with the selected inventory area highlighted on the map. This may allow the user to easily identify the store location related to the product counts 104, which may aid in allowing the user to go to that store location and verify the product counts 104. As another example, the RAS report may include a print area detail control 728 that, when selected, is configured to cause the manager device 132 to display a detailed listing of the product counts 104 for the selected inventory area either locally or to a remote printing device 126. An example detail listing is discussed in further detail with respect to FIG. 9 below.

As a further example, the RAS report may include an RAS approval control 730, that, when selected, is configured to cause the manager device 132 to indicate approval of the product counts 104 for the selected inventory area. When an area is selected as approved, the manager device 132 may send a message to the to the portable workstation device 110 indicating the change in inventory area status 128. In an example, for an inventory area that has been counted but not yet approved by an auditor manager, the RAS approval control 730 may be selected to transition the inventory area to a status of approved by the auditor manager but not yet approved by store manager. If, however, the inventory area is already approved by the auditor manager, the RAS approval control 730 may instead indicate that the area is already approved. When areas are approved by the auditor manager, they may then be available for review and approval by the store manager via a walkout report. In some examples, to allow auditor managers to view the reports available to store managers, the RAS report may include a toggle report control 732 configured to allow the manager device 132 to toggle between the RAS report and the walkout report.

FIG. 8 illustrates an example user interface 800 of the audit manager application 134 displaying a walkout report for a selected inventory area of the floorplan. The user interface 800 may be displayed, for example, responsive to user selection of the show walkout report command 508 from the details window 502 displayed for a selected inventory area of the floorplan view. As illustrated, the user interface 800 may include a title label 802 to indicate to the user that the user interface 800 is displaying a walkout report of the store currently being audited (e.g., for inventory area 7510 in the given example).

Similar to the RAS report, the walkout report may include a summary report section 702 including summary information with respect to the collected product counts 104 for the inventory area being reported, and a flagged count section 712 including summary information with respect to the collected product counts 104 that may require further confirmation. However, since which employees performed the counts may not be relevant to the store manager, the walkout report may not include the employee section count section 724 that is available in the RAS report.

Also similar to the RAS report, the walkout report may include controls that may be invoked to facilitate the review of the product counts 104 for the selected inventory area. For example, the walkout report may include a view area in map control 726 and a print area detail control 728. The walkout report may also include a print walkout report 804 that, when selected, is configured to cause the manager device 132 to request for the portable workstation device 110 to print a copy of the walkout report for the selected inventory area.

The walkout report may also include a walkout approval control 730, that, when selected, is configured to cause the manager device 132 to indicate store approval of the product counts 104 for the selected inventory area. In an example, for an inventory area that has been counted and approved by an auditor manager, the walkout approval control 730 may be selected to transition the inventory area to a status of approved by the store manager. If, however, the inventory area is already approved by the store manager, the walkout approval control 730 may instead indicate that the area is already approved. When areas are approved by the store manager, they may then be fully approved. In some examples, to allow auditor managers to toggle between RAS reports and walkout reports, the walkout report for auditor managers may include a toggle report control 732 as discussed above.

FIG. 9 illustrates an example user interface 900 of the audit manager application 134 displaying a detail report for a selected inventory area of the floorplan. The user interface 900 may be displayed, for example, responsive to user selection of the print area detail control 728 from the RAS report or the walkout report. As illustrated, the user interface 900 may include a title label 902 to indicate to the user that the user interface 900 is displaying a detail report (e.g., for section one of the inventory area 7510 in the given example).

The detail report may include a count listing 904 including a listing of each of the product counts 104 for the inventory location being reported. The count listing 904 may include data for each counted item, such as for example: a transaction number indicative of the batch of data received from the auditor device 106, a loop identifier of the individual count within the transaction, a SKU or other product identifier of the item, store department information in which the item is categorized such as department number and description (e.g., determined according to the price file 116), item unit price, counted item quantity, whether an auditor count edit was requested for the particular item, whether edits are pending approval for the current item, and an item detail control 722 configured to cause the manager device 132 to display an item details user interface for the selected item. The detail report may further include a link 906 that, when selected, causes the user interface to return to the RAS report or the walkout report from which the print area detail control 728 was selected.

FIG. 10 illustrates an example user interface 1000 of the audit manager application 134 displaying an item detail for a selected inventory area of the floorplan. The user interface 1000 may be displayed, for example, responsive to user selection of the item detail control 722 from the RAS report, the walkout report, or the detail report, as some possibilities. As illustrated, the user interface 1000 may include a title label 1002 to indicate to the user that the user interface 1000 is displaying an item detail report for the selected item (e.g., SKU 1834175126 in the given example).

Similar to the detail report, the item detail report may include a detail item listing 1004 including data descriptive of the count information for the detail item being reviewed. This information may include for example: transaction identifier, loop identifier, SKU, department, department description, item unit price, counted item quantity, and extension amount.

Moreover, the item detail report may further include an auditor device input control 1006 displaying the actual keystroke input provided by the operator of the auditor device 106 when counting the item. As shown, to reach the quantity of “2”, the operator entered the chain sequence “1+1” into the auditor device 106. By displaying the actual operator input, a viewer of the item detail report may be able to readily recognize errors present in the operator input. For example, the operator input may indicate a likely typographical error in keying in the product counts 104, such as “122+12+12” instead of a more likely “12+12+12”. As another possibility, the user of the manager device 132 may review the actual product items located on the shelf (e.g., go to section one of area 7510) to determine whether the product count 104 information is accurate. A user of the manager device 132 may accordingly use the various item reports (e.g., the flagged count sections 712 of the RAS reports or walkout reports) to target those items that appear to be likely of including an error, and for those items view the item detail report to review and potentially correct those entries.

The item detail report may also include count editing controls 1008 that may be used by the user of the manager device 132 to correct any errors identified in the product counts 104. For example, the count editing controls 1008 may include increment/decrement controls 1010 configured to allow a user to increase or decrease the product count 104. As another example, the count editing controls 1008 may include an editable count control 1012 into which a new count may be entered by a user. The count editing controls 1008 may also include a difference control 1014 configured to display a difference between the product count 104 and the updated product count 104 being entered. When changed, the count editing controls 1008 may add the change in product count 104 to a list of pending updates. If, however, the user elects to cancel a change made to the product count 104 before it is entered as a pending update, the user may utilize a clear edit count control 1016 to cancel the current edit.

In some cases, an item may appear in multiple locations within the store (e.g., in a location other section one of the area 7510). Accordingly, the item detail report may include an all SKU locations control 1018 configured to display a report view of the product counts 104 for the item regardless of location within the store. The item detail report may also include a return control 1020 configured to display the RAS report or walkout report from which the item detail report was selected.

FIG. 11 illustrates an example user interface 1100 of the audit manager application 134 displaying an auditor count edits screen. The user interface 1100 may be displayed, for example, responsive to user selection of the auditor count edits control from one of the user interfaces 200-1000. As illustrated, the user interface 1100 may include a title label 1102 to indicate to the user that the user interface 1100 is displaying the auditor count edits screen.

The auditor count edits screen may include a list of the pending edits 1104 to the product counts 104 made via the item detail report as discussed above. The list of the pending edits 1104 may include information about each pending edit, such as transaction identifier, loop identifier, inventory area number and section, SKU, SKU description, the quantity to be changed, the new quantity, a difference between the old and new quantities, and a difference in the extension amount between the old and new quantities. In the illustrated example, a pending edit of the quantity of a 20×20 dust pollen air filter from a quantity of 4 units to a quantity of 6 units is listed, with a resultant difference in extension of $17.78.

For each listed pending edit, the pending edits 1104 may further include an approve control 1106 configured to cause the system 100 to accept the pending edit, and a reject control 1108 configured to cause the system to reject the pending edit. The auditor count screen may also include an approve all store edits control 1110 configured to cause the system to accept all pending edits. To facilitate review of the edits, the auditor count edits screen may also include a filter control 1112 configured to allow a user to filter the edits to include, as some examples, all edits whether approved or pending, all pending edits for which approval or rejection action is required, or all committed edits for which approval or rejection has been obtained. Accordingly, a user of the auditor count edits screen may be able to review and approve any changes to the product counts 104, thereby verifying and improving the quality of the auditor counts 104.

FIG. 12 illustrates an example user interface 1200 of the audit manager application 134 displaying a high value items screen. The user interface 1200 may be displayed, for example, responsive to user selection of the high value control from the feature list 216. As illustrated, the user interface 1200 may include a title label 1202 to indicate to the user that the user interface 1200 is displaying the high value items screen. The user interface 1200 may further include a high value item count section 1204 including a listing of product counts 104 of items that exceed predetermined configurable quantity and dollar extension values.

Similar to the flagged count section 712, the high value item count section 1204 may include summary information with respect to high value the collected product counts 104 that may require further confirmation. As shown, the illustrated high value item count section 1204 lists product counts 104 for items throughout the store for which the quantity is over a threshold (e.g., 100 units), and/or where the extension amount exceeds a dollar threshold (e.g., $250.00). For each item, the high value item count section 1204 further illustrates information about the flagged count, such as the area, section, SKU, SKU description (e.g., from the price file 116), department, unit price, quantity, and extension amount. To facilitate understanding of why the line item is included in the high value item count section 1204, the line items may be illustrated with criteria indications 1206 illustrating which element of the line item for the product count 104 caused the product count 104 to be flagged for inclusion. The high value item count section 1204 may further support sorting by quantity (e.g., high to low) and extension (e.g., high to low), to allow a user to review to catch any obvious count or keying errors.

To facilitate review of the high value items, the high value items screen may also include a filter control 1208 configured to allow a user to filter the line items of the high value item count section 1204 to include, as some examples, all counted values whether approved or pending, all counted value edits for which approval or rejection action is received, and all counted value edits for which approval or rejection action is required. Accordingly, a user of the high value items screen may be able to review and approve the high value product counts 104 across the store.

FIG. 13 illustrates an example user interface 1300 of the audit manager application 134 displaying an overrides screen. The user interface 1300 may be displayed, for example, responsive to user selection of the overrides control from the feature list 216. As illustrated, the user interface 1300 may include a title label 1302 to indicate to the user that the user interface 1300 is displaying the overrides screen. The user interface 1300 may further include an overrides list 1304 including a listing of universal product code (UPC) overrides and entries with price lookup codes (PLUs) that have been entered by operators of the auditor devices 106. The user interface 1300 may further include an override filter control 1306 configured to allow a user to filter the overrides list 1304 by criteria such as inventory area, inventory area section, department, SKU, price, keyed price, quantity, and all overrides. A user of the overrides screen may, for example, sort the overrides by price point to review the prices that have been manually entered for not-on-file UPCs and PLU entries. A user may accordingly verify the accuracy of the price points that have been manually keyed in by the operators of the auditor devices 106.

FIG. 14 illustrates an example user interface 1400 of the audit manager application 134 displaying a missing areas screen. The user interface 1400 may be displayed, for example, responsive to user selection of the missing areas control from the feature list 216. As illustrated, the user interface 1400 may include a title label 1402 to indicate to the user that the user interface 1400 is displaying the missing areas screen. The user interface 1400 may further include a missing areas/sections list 1404 including a listing of inventory areas of the store and/or sections of inventory areas for which no product counts 104 have been received. The user interface 1400 may also include an out-of-range list 1406 including a listing of inventory areas outside the floorplan model 102 for which product counts 104 have been received. A user of the missing areas screen may accordingly be able to review areas that may have been missed during the inventory count, as well as areas that should be added to the floorplan model 102.

FIG. 15 illustrates an example user interface 1500 of the audit manager application 134 displaying a duplicate areas/sections screen. The user interface 1500 may be displayed, for example, responsive to user selection of the duplicate areas control from the feature list 216. As illustrated, the user interface 1500 may include a title label 1502 to indicate to the user that the user interface 1500 is displaying the duplicate areas screen. The user interface 1500 may further include a duplicate areas/sections list 1504 including a listing of inventory areas of the store for which product counts 104 have been received from multiple auditor devices 106. The duplicate areas/sections list 1504 may include information such as transaction identifier, inventory area identifier, section identifier, auditor device 106 operator name, counted quantity, and extension amount. When selected, the entries of the duplicate areas/sections list 1504 may be configured to provide a display of the product counts 104 of for the associated operator and section. Accordingly, a user of the duplicate areas screen may accordingly be able to review areas to determine whether sections have been counted multiple times, or whether multiple operators counted different portions of a section or inventory area without overlap.

FIG. 16 illustrates an example process 1600 for retrieving audit packages 114 for upcoming inventory audits. The process 1600 may be performed, for example, by a portable workstation device 110 in communication with a remote server 138.

At operation 1602, the portable workstation device 110 identifies upcoming in-store audits. In an example, the portable workstation device 110 may be configured to access the appointment schedule 142 of the remote server 138 to determine the next audit or audits scheduled to be performed using the portable workstation device 110.

At operation 1604, the portable workstation device 110 retrieves audit packages 114 corresponding to the identified upcoming audits. As some possibilities, based on the appointment schedule 142 of the remote server 138, the portable workstation device 110 may retrieve the audit package 114 for the next audit to be performed, the audit packages 114 for the next day of audits to be performed, or the audit packages 114 for the next week of audits to be performed.

At operation 1606, the portable workstation device 110 performs the in-store audits. For example, the portable workstation device 110 may receive product counts 104 from the auditor devices 106, and inventory area statuses 128 from the manager devices 132, as discussed in detail above and below with respect to the process 1700.

At operation 1608, the portable workstation device 110 updates the audit packages 114 corresponding to the completed audits. For example, the portable workstation device 110 may be configured to access the remote server 138 to upload the completed audit status information 124 for the completed in-store audits. The completed audit status information 124 may be archived for later viewing. The completed audit status information 124 may also be used to update previous product counts 104 of the audit packages 114 for comparison purposes for later-performed audits of the stores. After operation 1608, the process 1600 ends.

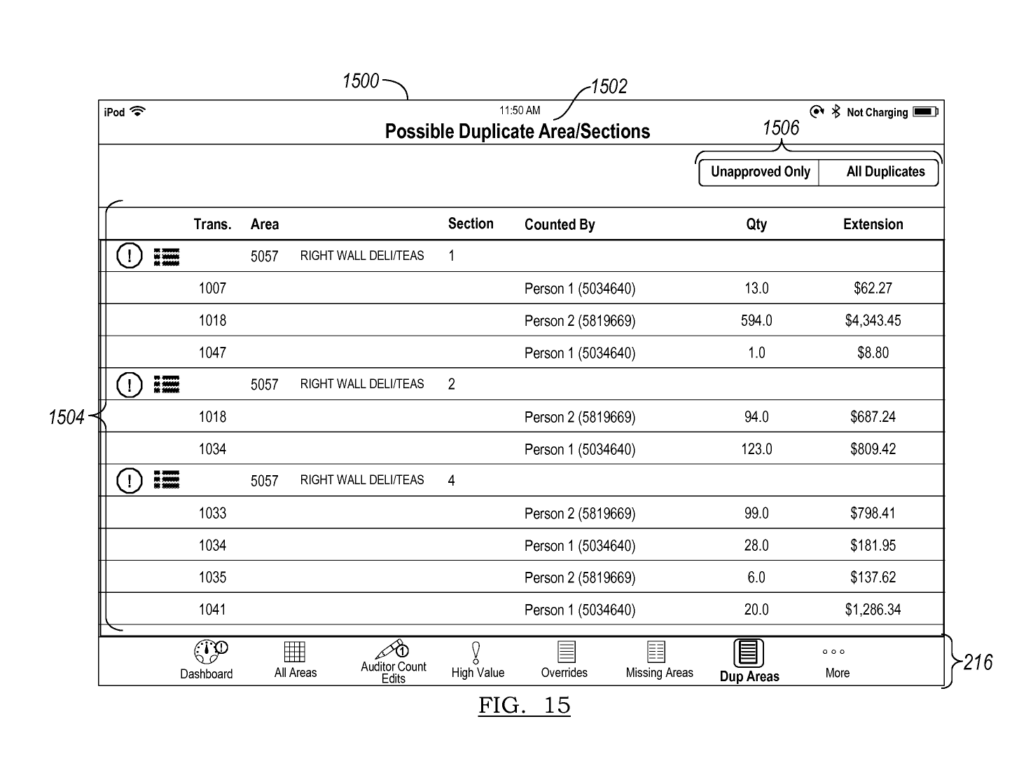

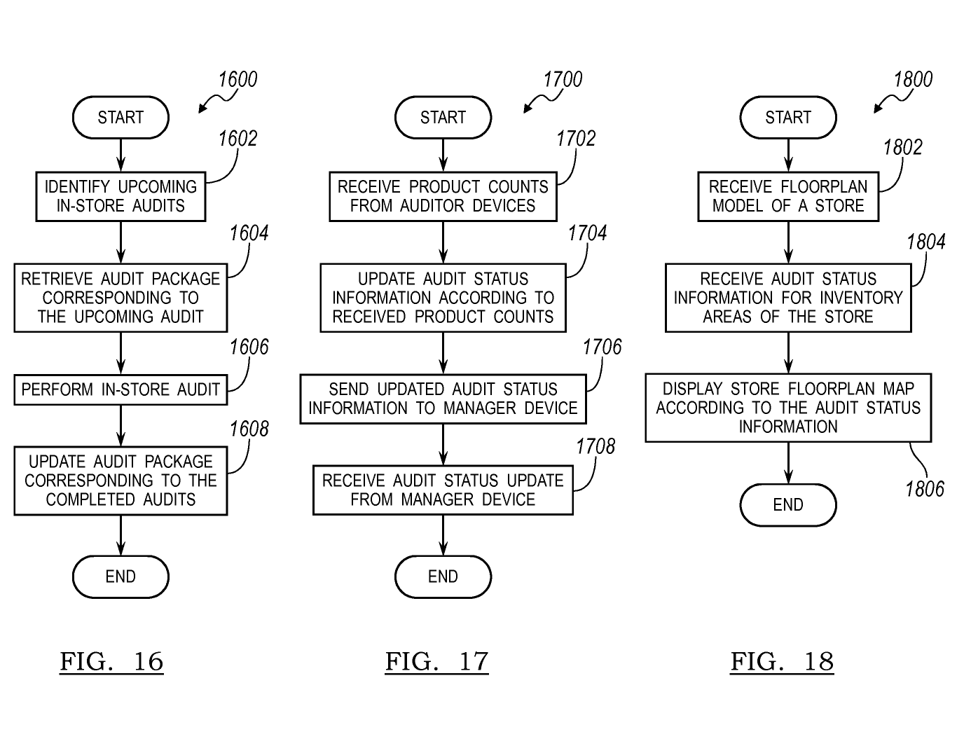

FIG. 17 illustrates an example process 1700 for performing an in-store inventory audit of a store. The process 1700 may be performed, for example, by a portable workstation device 110 in communication with one or more manager devices 132 and auditor devices 106.

At operation 1702, the portable workstation device 110 receives product counts 104 from the one or more auditor devices 106. For example, the auditor device hub 108 may be connected to the portable workstation device 110, and may be configured to facilitate secure communication between the portable workstation device 110 and the various auditor devices 106 being used throughout the store. When an operator of the auditor device 106 completes an audit of a section of an inventory area, the operator may select an upload function of the auditor device 106 configured to provide the product counts 104 for that counted section to the portable workstation device 110 via the auditor device hub 108.

At operation 1704, the portable workstation device 110 updates audit status information 124 according to the received product counts 104. For example, the portable workstation device 110 may maintain audit status information 124 including product counts 104 of the inventory areas of the store being counted, as well as inventory area statuses 128 relating to the level of completion and manager review of the product counts 104 for the inventory areas. The inventory areas may be defined, for example, according to a floorplan model 102 of the audit package 114 of the store currently being audited.

At operation 1706, the portable workstation device 110 sends updated audit status information 124 to the one or more manager devices 132. In an example, the portable workstation device 110 may communicate the audit status information 124 to the audit manager application 134 executed by the manager devices 132 via the auditor device hub 136. Using the audit manager application 134, the manager devices 132 may be configured to display a dashboard indicative of the overall status of the product counts 104, as well as provide a display of the floorplan model 102 to provide a detailed visual representation of the progress of the inventory audit of the store. Using the display of the floorplan model 102, an operator of the manager device 132 may be able to review and approve areas for which inventory has been collected for store review.

At operation 1708, the portable workstation device 110 receives audit status updates from the one or more manager devices 132. In an example, the audit status updates may include an indication of an update to the inventory area status 128 of current product counts 104 for the inventory areas of the store. After operation 1708, the process 1700 ends.

FIG. 18 illustrates an example process 1800 for displaying a floorplan map of an in-progress inventory audit of a store. The process 1800 may be performed, for example, by a manager device 132 in communication with the portable workstation device 110 managing the in-store inventory audit.

At operation 1802, the manager device 132 receives a floorplan model 102 of a store. For example, the manager device 132 may receive the floorplan model 102 from the portable workstation device 110 based on the audit package 114 of the store currently being audited by the portable workstation device 110.

At operation 1804, the manager device 132 receives audit status information 124 for an in-progress audit of the store. In an example, the manager device 132 may request and receive the audit status information 124 responsive to user input to an update now control 214. Additionally or alternately, the audit status information 124 may be periodically or otherwise automatically downloaded from the portable workstation device 110 by the manager device 132.

At operation 1806, the manager device 132 displays a store floorplan map according to the audit status information 124. The floorplan map may include a plurality of inventory areas of the floorplan model 102 illustrated, at their relative locations within the store, with appearances corresponding to their respective inventory area statuses 128. In an example, the manager device 132 may display the sections of the floorplan model 102 in different colors, patterns, or textures. The manager device 132 may further display a key 408 configured to illustrate meanings of the various colors, patterns, or textures in which the floorplan model 102 is displayed. A user of the manager device 132 may according be able to visually review and approve of the product counts 104 for the inventory audit. After operation 1806, the process 1800 ends.

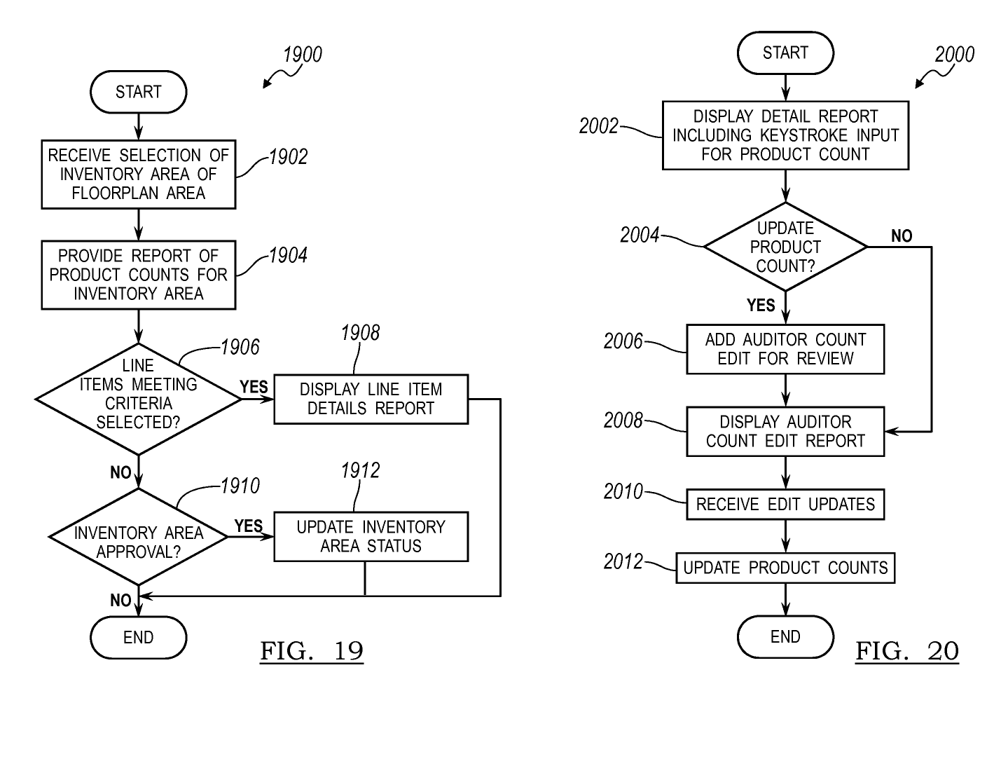

FIG. 19 illustrates an example process 1900 for reviewing and approving product counts 104 of an in-progress inventory audit of a store. The process 1900 may be performed, for example, by a portable workstation device 110 in communication with one or more manager devices 132 and auditor devices 106.

At operation 1902, the manager device 132 receives a selection of an inventory area from the floorplan map. In an example, the user may select an inventory area from the store floorplan map displayed by the manager device 132 in accordance with the process 1800 described in detail above.

At operation 1904, the manager device 132 provides a report of product counts 104 for the selected inventory area. For example, responsive to the selection in operation 1902, the manager device 132 may display a details window 502 of the selected inventory area of the floorplan view. If the user is an auditor user, the details window 502 may include a show RAS report command 508 that, when selected, is configured to cause the manager device 132 to display the RAS report including details of the selected inventory area. As another example if the user is an auditor user or a store manager user, the details window 502 may include a show walkout report command 510 that, when selected, is configured to cause the manager device 132 to display the walkout report including details of the selected inventory area. An example RAS report is discussed above with respect to the user interface 700, and an example walkout report is discussed above with respect to the user interface 800.

At operation 1906, the manager device 132 determines whether selection of a line item meeting criteria is selected. For example, the displayed report may include a flagged count section 712 including summary information with respect to the collected product counts 104 that may require further confirmation. The user may select a line item from the flagged count section 712 of the RAS report or walkout report to view details of the selected item.

At operation 1908, the manager device 132 displays an item detail report for the selected line item. An example item detail report is discussed above with respect to the user interface 1000. A user of the manager device 132 may accordingly use the various item reports (e.g., the flagged count sections 712 of the RAS reports or walkout reports) to target those items that appear to be likely of including an entry or other error.

At operation 1910, the manager device 132 determines whether the inventory area is approved. For example, the displayed report may include an RAS approval control 730 may be selected to transition the inventory area status 128 to a status of approved by the auditor manager but not yet approved by store manager. In another example, for an inventory area that has been counted and approved by an auditor manager, the displayed report may include a walkout approval control 730 that may be selected to transition the inventory area status 128 to a status of approved by the store manager. If the user requests an update to the inventory area status, control passes to operation 1912. Otherwise, the process 1900 ends.

At operation 1912, the manager device 132 updates the inventory area status associated with the inventory area. For example, the manager device 132 may send updated inventory area statuses 128 to the portable workstation device 110 to cause the portable workstation device 110 to update the inventory area statuses 128 in accordance with the user update. After operation 1912, the process 1900 ends.

FIG. 20 illustrates an example process 2000 for updating a product count 104 for an item counted during in-progress inventory audit of a store. The process 2000 may be performed, for example, by a portable workstation device 110 in communication with one or more manager devices 132 and auditor devices 106.

At operation 2002, the manager device 132 displays the item detail report. The item detail report may be displayed, for example, as discussed above with respect to the process 1900. The item detail report may include an auditor device input control 1006 displaying the actual keystroke input provided by the operator of the auditor device 106 providing the product count 104 for the item.

At operation 2004, the manager device 132 determines whether to update the product count 104 for the item. For example, if the user inputs an updated quantity for the product count 104 using the item detail report, control passes to operation 2006. Otherwise control passes to operation 2008.

At operation 2006, the manager device 132 adds the updated product count 104 for the time to a listing of updated product counts 104 for auditor review.

At operation 2008, the manager device 132 displays an auditor counts edits screen. In an example, the manager device 132 may receive a user selection of the auditor counts edit control of the feature list 216 displayed by the manager device 132. Responsive to the selection, the manager device 132 may display the auditor count edits screen. An example auditor count edits screen is discussed above with respect to the user interface 1100.

At operation 2010, the manager device 132 receives edit updates. For example, manager device 132 may receive input to an approve control 1106 configured to cause the system 100 to accept the pending edit, to a reject control 1108 configured to cause the system to reject the pending edit, or to an approve all store edits control 1110 configured to cause the system to accept all pending edits.

At operation 2012, the manager device 132 updates the product counts 104. For example, the manager device 132 may provide the approval or disapproval of the updated product counts 104 to the portable workstation device 110 responsive to the user input in operation 2010. Accordingly, a user of the auditor count edits screen may be able to review and approve any changes to the product counts 104, thereby verifying and improving the quality of the auditor counts 104. After operation 2012, the process 2000 ends.

Computing devices described herein, such as the auditor devices 106, portable workstation device 110, manager devices 132, remote server 138, and remote access devices 148, generally include computer-executable instructions, where the instructions may be executable by one or more computing devices such as those listed above. Computer-executable instructions (such as those of the data store 112, audit server application 130, audit manager application 134, remote data store 140, and audit monitor application 144 may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a portable workstation device configured to
update an inventory area status associated with an inventory area of a store undergoing an in-progress inventory audit, responsive to receipt of product counts from an auditor device; and
provide the inventory area status to a manager user device configured to display a floorplan map of the store, the floorplan map including a plurality of inventory areas illustrated, at their relative locations within the store, with appearances corresponding to their respective inventory area statuses.

2. The system of claim 1, wherein the portable workstation device is further configured to provide, to the manager device, a floorplan model of the store including information indicative of locations of the inventory areas within the store for display of the floorplan map.

3. The system of claim 1, further comprising receiving an audit package including a floorplan model of the store and a price list including price information for inventory items of the store.

4. The system of claim 3, further comprising:
receiving the audit package from a remote server prior to performing the inventory audit; and
sending the product counts of the inventory items to the remote server.

5. The system of claim 1, further comprising:
receiving validation information from the manager device indicative of an update in inventory area status for an inventory area of the store; and
updating the inventory area status for the inventory area of the store responsive to receipt of the validation information.

6. The system of claim 5, wherein at least one of:
the manager device is an auditor manager device, and the update in inventory area status is from an inventory area status of counted-but-unapproved to an inventory area status of auditor-approved; and
the manager device is a store manager device, and the update in inventory area status is from the inventory area status of auditor-approved to an inventory area status of store-approved.

7. The system of claim 1, wherein the inventory area status includes at least two of: an area status of unknown status, an area status of uncounted; an area status of count in progress;
an area status of auditor-approved and ready for store review; and an area status of store-approved.

8. The system of claim 1, wherein the appearances include at least one of:
different colors corresponding to each unique area status and different patterns corresponding to each unique area status.

9. A system comprising:
a portable inventory manager device configured to
receive, from a portable workstation device managing an in-progress inventory audit of a store, area status information indicative of progress of the inventory audit for a plurality of inventory areas of a floorplan model of a store, the floorplan model defining locations of inventory areas within the store; and
display a floorplan map of the store according to the floorplan model, the floorplan map including a plurality of the inventory areas of the floorplan model illustrated, at their relative locations within a store, with appearances corresponding to the respective area status information for the corresponding inventory areas.

10. The system of claim 9, wherein the portable inventory manager device is further configured to receive the floorplan model of the store from the portable workstation device.

11. The system of claim 9, wherein the portable inventory manager device is further configured to:
receive a user selection of an inventory area of the floorplan model; and
display a listing of product counts of inventory items corresponding to the selected inventory area.

12. The system of claim 9, wherein the portable inventory manager device is further configured to:
receive user input indicative of an update in inventory area status for an inventory area of the store; and
send the update in inventory area status for the inventory area of the store to the portable workstation device responsive to receipt of the user input.

13. The system of claim 12, wherein the manager device is an auditor manager device, and the update in inventory area status is from an inventory area status of counted-but-unapproved to an inventory area status of auditor-approved.

14. The system of claim 12, wherein the manager device is a store manager device, and the update in inventory area status is from an inventory area status of auditor-approved to an inventory area status of store-approved.

15. A non-transitory computer-readable medium comprising instructions of an audit manager application that, when executed by a processor of a manager device, cause the manager device to perform operations including to:
receive, from a portable workstation device managing an in-progress inventory audit of a store, area status information indicative of progress of the inventory audit for a plurality of inventory areas of a floorplan model of a store, the floorplan model defining locations of inventory areas within the store; and
display a floorplan map of the store according to the floorplan model, the floorplan map including a plurality of the inventory areas of the floorplan model illustrated, at their relative locations within a store, with appearances corresponding to the respective area status information for the corresponding inventory areas.

16. The medium of claim 15, further comprising instructions configured to cause the manager device to receive the floorplan model of the store from the portable workstation device.

17. The medium of claim 15, further comprising instructions configured to cause the manager device to:
receive a user selection of an inventory area of the floorplan model; and
display a listing of product counts of inventory items corresponding to the selected inventory area.

18. The medium of claim 15, further comprising instructions configured to cause the manager device to:
receive user input indicative of an update in inventory area status for an inventory area of the store; and
send the update in inventory area status for the inventory area of the store to the portable workstation device responsive to receipt of the user input.

19. The medium of claim 18, wherein the manager device is an auditor manager device, and the update in inventory area status is from an inventory area status of counted-but-unapproved to an inventory area status of auditor-approved.

20. The medium of claim 18, wherein the manager device is a store manager device, and the update in inventory area status is from an inventory area status of auditor-approved to an inventory area status of store-approved.
